(19) United States
(12) Patent Application Publication
(10) Pub. No.: US 2016/0092459 A1
(43) Pub. Date: Mar. 31, 2016

(54) TRANSLATING A KEYWORD SEARCH INTO A STRUCTURED QUERY

(71) Applicant: LinkedIn Corporation, Mountain View, CA (US)

(72) Inventors: Zhifang Liu, Sunnyvale, CA (US); Steven Foote, Santa Clara, CA (US); Daniel Tunkelang, Mountain View, CA (US); Ashley Woodman Hall, Menlo Park, CA (US); Asif Mansoor Ali Makhani, Fremont, CA (US)

(21) Appl. No.: 14/500,545

(22) Filed: Sep. 29, 2014

(51) Int. Cl. G06F 17/30

(52) U.S. Cl. CPC G06F 17/3097

(57) ABSTRACT

Method and system to generate structured queries is described. The system may be configured to examine an input string submitted by a user via a search box and present suggestions that may include references to entities grouped by entity type. The search system examines the input string, determines one or more entity types that may correspond to the input string, and provides suggestions that may be the form of one or more of keywords and also in the form of values of or references to typed entities.

### TECHNICAL FIELD

This application relates to the technical fields of software and/or hardware technology and, in one example embodiment, to system and method to generate structured queries.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. A member profile in an on-line social network system may also represent a group, a company, a school, etc. Member profiles in an on-line social network system may be referred to as simply profiles.

An on-line social network system may include a search system that permits members to search information, such as, e.g., jobs postings, people, etc., within an on-line social network. The searches within the on-line social network may be viewed as navigational (where the intent of the search—search intent—is to locate a specific item, e.g., a particular person) or exploratory (where the intent of the search is to scan through the available information in order to identify potentially interesting or useful items). A navigational search may be fairly specific (e.g., indicating the first and last name of a person). An exploratory search, on the other hand, may return a great number of search results, which may sometimes make it difficult to identify those search results that are most useful. A search system may process a search request by matching a search string against the stored content to determine, which documents or records contain the search string. The documents that contain the search string, or references to those documents, are returned as search results. A search system may obtain a search string, e.g., by accessing input provided by a user via a search box presented as part of Graphical User Interface (GUI).

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate structured queries may be implemented;

FIG. 2 is block diagram of a system to generate structured queries, in accordance with one example embodiment;

FIG. 3 is a flow chart of a method to generate structured queries, in accordance with an example embodiment; and

FIG. 4 is an example User Interface screen illustrating presentation of suggestions grouped by entity type, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to generate structured queries in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, provide recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.).

The profile of a member may also include information about the member's current and past employment, such as company identifications, professional titles held by the associated member at the respective companies, as well as the member's dates of employment at those companies. A professional title that may be present in a member profile and indicate a professional position of the member during a particular period of employment may be referred to as a title string. Thus, a title string that appears in a member profile may be associated with a particular company and also with a period of time during which the member held, at that company, a particular position.

As mentioned above, an on-line social network system may include a search system that permits members to search for a wide range of information. In one embodiment, a search system may be configured to generate structured queries using one or more techniques described below. Method and system are described for assisting users in the process of formulating search criteria and generating so-called structured queries (also referred to as compound graph queries). A query that is processed by matching one or more keywords against the entire content of a document or a record may be referred to as an unstructured query. A structured query, on the other hand, is a query that is processed by examining some but not all fields in a document to determine whether the content stored in those one or more selected fields contains a search string included in the query. A structured query that is processed by examining some but not all fields in a document may be referred to as a fielded query. A fielded query includes a string that is identified by the search system as an entity of a particular entity type. The search system is then able to determine whether that particular entity type is associated with one or more specific fields in the collection of documents and, if so, search only those specific fields in the documents from the collection. Strings that have been tagged with or identified as being of a particular entity type are entities of that particular entity type. For example, a string “Michael Smith” may be identified by the search system as an entity of type “people.” A string “LinkedIn” may be identified by the search system as an entity of type “companies.”

Another example of a structured query is a so-called faceted query, where, rather than matching text, a search system matches identifiers (ID's). For example, an entity of type “companies” may be a string “LinkedIn,” which also has an ID. In the member profiles, the company that corresponds to the “Linkedin” string has the same ID. When a user requests a search for “LinkedIn,” the search system determines the ID assigned to the “LinkedIn” string and matches the ID assigned to the “LinkedIn” string with IDs stored in the member profiles. For example, if the entity “LinkedIn” is assigned company ID 1337 in the on-line social network system, a query including the entity “LinkedIn” would result in the search system returning member profiles that are assigned 1337 as an ID in the Current Company facet associated with the profiles.

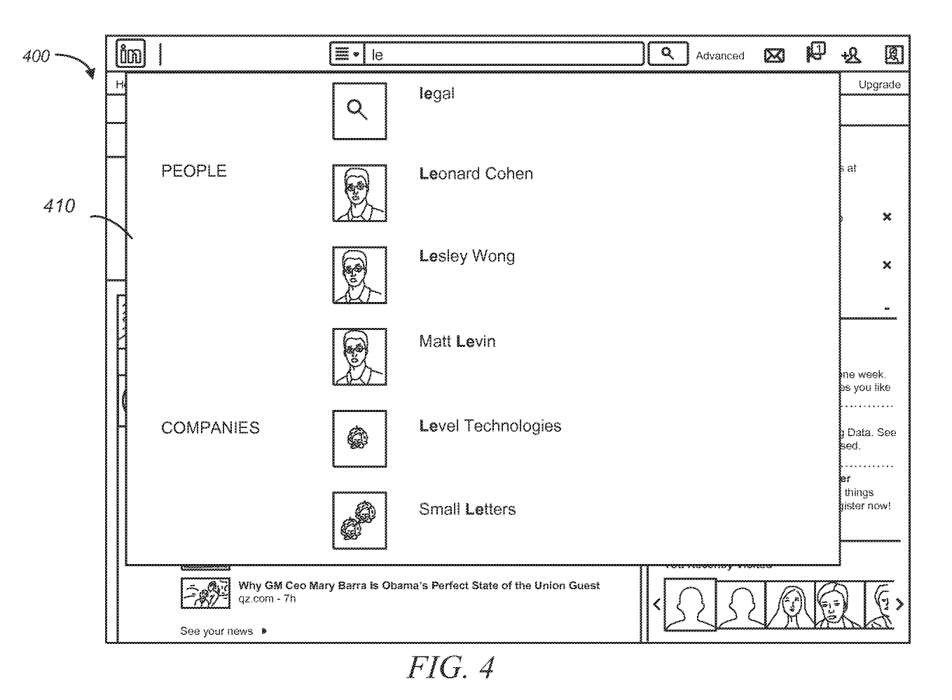

A search system may obtain a search string, e.g., by accessing input provided by a user via a search box presented as part of Graphical User Interface (GUI). In one embodiment, a search system may be configured to examine an input string submitted by a user via a search box and present suggestions that may include references to entities grouped by entity type. The search system examines the input string, determines one or more entity types that may correspond to the input string, and provides suggestions that may be the form of one or more of keywords (that may be autocompleted versions of the input string) and also in the form of values of or references to typed entities, e.g., references to profiles of members in an on-line social network system. For example, as shown on screen 400 in FIG. 4, when a user types a sequence “le” in the search box, the search system presents a drop down list that includes a keyword that starts with the sequence “le” (“legal”), includes references to a few suggested profiles in the on-line social network system representing people whose first or last name starts with “le,” and also includes references to a few suggested profiles of companies that include words that start with “le.” In the example shown in FIG. 4, the search system selected two entity types—“people” and “companies”—and included references to entities of those types into the list of suggestions provided in area 410. Other selected entity types may include “groups,” “showcase pages,” etc. The search system may thus be described as capable of translating a keyword search into a structured query.

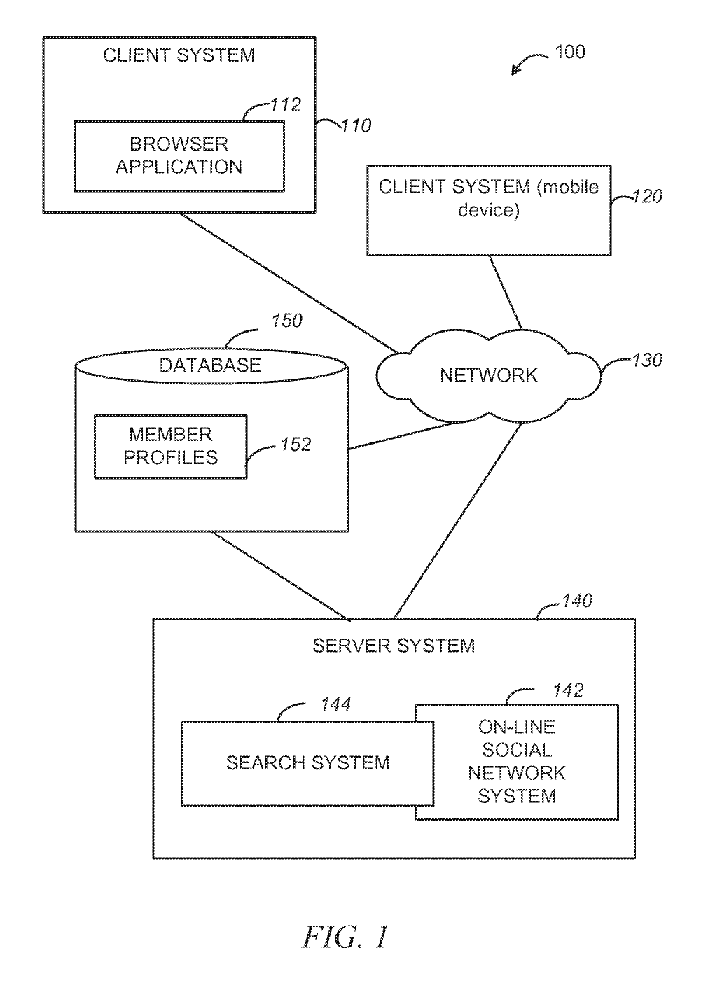

As shown in FIG. 4, in the list of suggestions presented in the area 410, the references to entities of type “people” are presented at the top of the list, while references to entities of type “companies” are presented further down the list. The selection of the order of presentation of entity-type-based grouped suggestions may be random or based on one or more business rules. For example, in one embodiment, the search system may examine previously collected and stored historical information regarding the frequency of particular types of queries performed by users (e.g., by members of the on-line social network system), determine that more searches are for people than for companies, and, based on this determination, present references to entities of type “people” at the top of the list of suggestions. Example method and system to generate structured queries may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

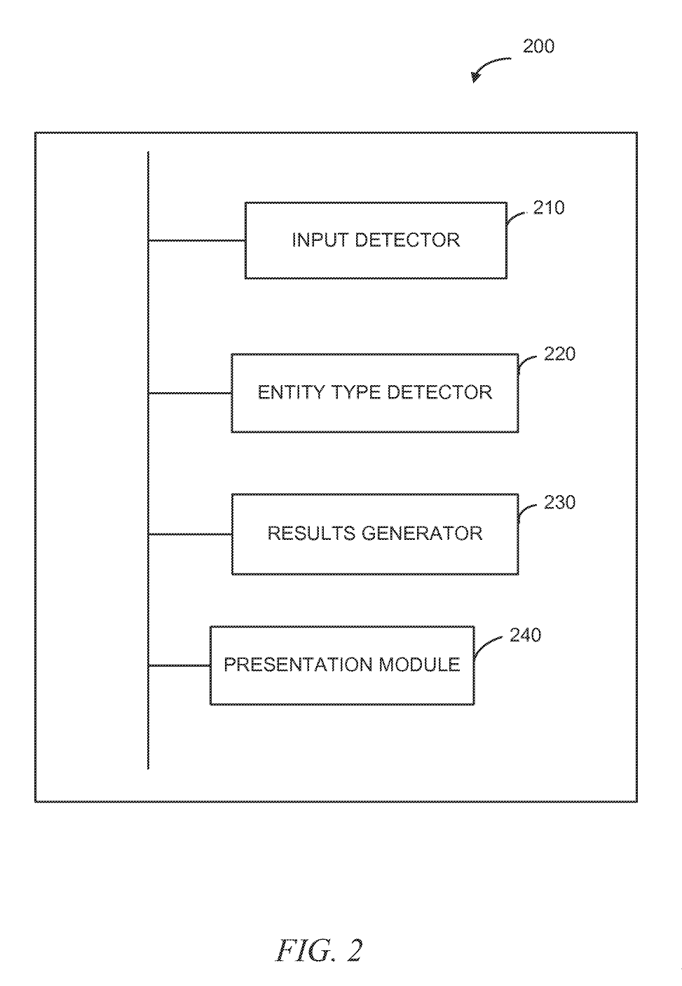

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a search system 144 that may be utilized beneficially to aid users in formulating a search request and building a structured query. The search system 144 may be configured to obtain a search string, e.g., by accessing input provided by a user via a search box presented as part of Graphical User Interface (GUI). As explained above, on one embodiment, the search system 144 may be configured to examine an input string submitted by a user via a search box and present suggestions that may include references to entities grouped by entity type. The search system 144 examines the input string, determines one or more entity types that may correspond to the input string, and provides suggestions that may be the form of one or more of autocompleted keywords and also in the form of values of or references to typed entities, e.g., references to profiles of members in the on-line social network system 144, as illustrated in FIG. 4. An example search system 144 is illustrated in FIG. 2.

FIG. 2 is a block diagram of a system 200 to generate structured queries, in accordance with one example embodiment. As shown in FIG. 2, the system 200 includes an input detector 210, an entity type detector 220, a results generator 230, and a presentation module 240. The input detector 210 may be configured to detect an input string in a search box presented on a display device as part of a user interface of a computing application. In one embodiment, the computing application may be the on-line social network system 142 of FIG. 1 that maintains a plurality of member profiles 152 stored in the database 150 of FIG. 1. A profile stored in the database 150 may represent a person, a company, an educational institution, a group, etc.

The entity type detector 220 may be configured to select an entity type in response to the detecting of an input string in the search box, and to determine, which field in the profiles corresponds to the selected entity type. For example, as described with reference to FIG. 4 above, a user may type the string “le.” The entity type detector 220 may first select an entity type “people” and then determine that the entity type “people” is associated with profiles that represent people and is also associated with a section (or field) in a member profile that is designated for storing information representing the name of a member. The results generator 230 may be configured to examine, in the profiles, only the section (or field) that corresponds to that selected entity type in order to generate a list of suggestions. For a selected entity type, the results generator 230 may also be configured to examine only those profiles from the plurality of profiles that represent respective entities of the selected entity type (in this example, only the profiles that represent people) and not the profiles that represent respective entities of other entity types (such as profiles that represent companies or groups).

The entity type detector 220 may then select another entity type, e.g., “companies,” and then determine that the entity type “companies” is associated with profiles that represent companies and is also associated with a section (or field) in a member profile that is designated for storing information representing the name of a company. The results generator 230 may be configured to examine, in the profiles, only the section (or field) that is designated for storing information representing the name of a company in order to identify further entities to be included in the list of suggestions.

The presentation module 240 may be configured to cause presentation of the list of suggestions on the display device of a user who initiated the search. The list of suggestions may include links to profiles in the on-line social network system 142, where the links are grouped based on respective entity types. Thus, as shown in FIG. 4, the items presented in area 410 include items grouped based on their respective entity types. The list of suggestions may also include a keyword, which may be determined based on the input string.

The input detector 210 may be configured to detect a selection of an item from the list of suggestions. In response, the presentation module 240 may cause presentation, on the display device, information from a profile represented by the selected item. The presentation module 240 may be further configured to cause presentation of an invitation, in the search box, to search for items of a specified entity type based on the specified entity type of the item selected from the list of suggestions. For example, if a user selected, from the list of suggestions, a link to a profile representing a company, the presentation module may present information from that profile and also present, in the search box, the text “Search companies . . . ”

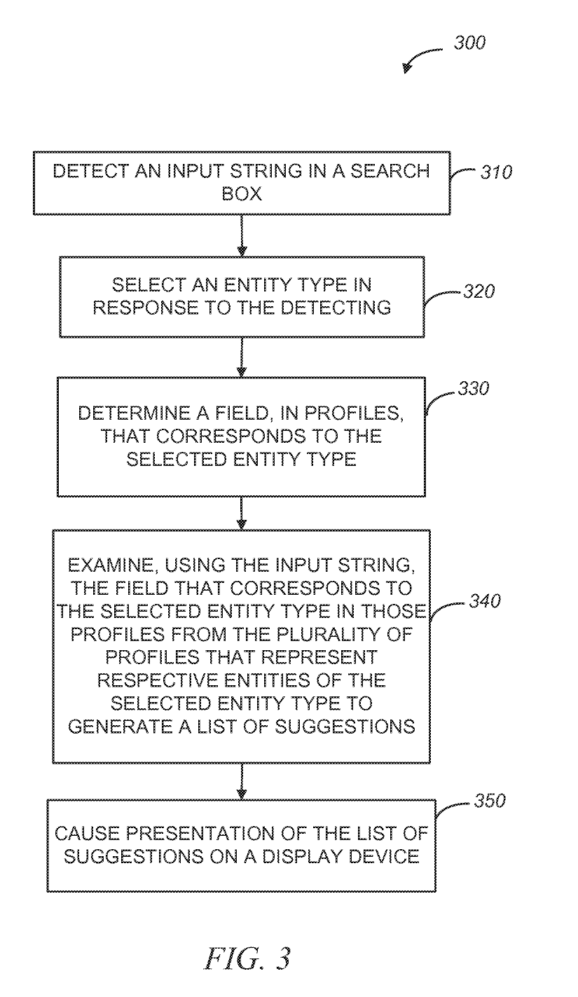

The input detector 210 may be further configured to detect a selection of a keyword from the list of suggestions. The entity type detector 220 may be further configured to determine an entity type associated with the keyword and a field in profiles in the plurality of profiles that corresponds to entity type associated with the keyword. The results generator 230 may be configured to examine the field that corresponds to entity type associated with the keyword in those profiles from the plurality of profiles that represent respective entities of the determined entity type and include, in search results, those profiles from the plurality of profiles that represent respective entities of the determined entity type and that also include the keyword in the subject field. The presentation module 240 may be configured to cause presentation, on the display device, of the search results. Some operations performed by the system 200 may be described with reference to FIG. 3.

FIG. 3 is a flow chart of a method 300 to generate structured queries, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the input detector 210 of FIG. 2 detects an input string in a search box presented on a display device as part of a user interface of a computing application. As stated above, the computing application may be the on-line social network system 142 of FIG. 1 that maintains a plurality of member profiles 152 stored in the database 150 of FIG. 1. At operation 320, the entity type detector 220 of FIG. 2 selects an entity type in response to the detecting of the input string in the search box, determines, at operation 330, which field in the profiles corresponds to the selected entity type. At operation 340, the results generator 230 of FIG. 2 examines, in the profiles, only the section (or field) that corresponds to that selected entity type in order to generate a list of suggestions. The presentation module 240 of FIG. 2 causes presentation of the list of suggestions on the display device of a user who initiated the search, at operation 350. As explained above, the list of suggestions may include links to profiles in the on-line social network system 142, where the links are grouped based on respective entity types.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

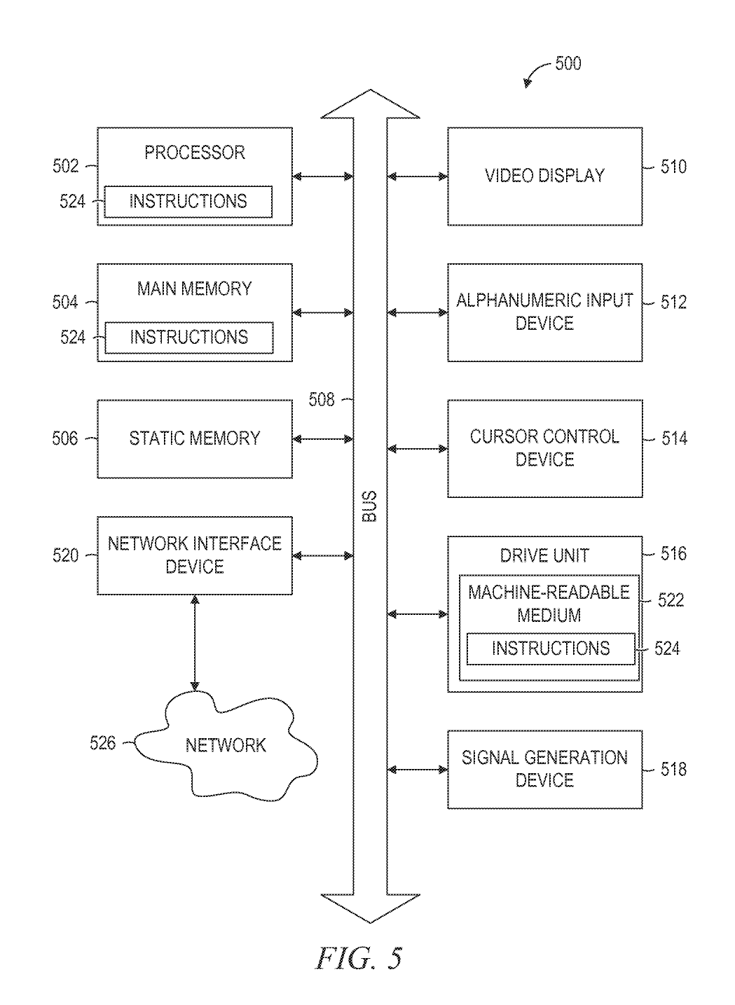

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to generate structured queries have been described. While the techniques for formulating a search query have been described with reference to searches in the context of an on-line social network system, the method and system to generate structured queries may be used beneficially in any context where electronic search results are being requested and retrieved. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
detecting an input string in a search box, the search box presented on a display device as part of a user interface of a computing application, the computing application maintaining a plurality of profiles;
selecting an entity type in response to the detecting, using at least one processor;
determining a field, in profiles in the plurality of profiles, that corresponds to the selected entity type;
using the input string, examining the field that corresponds to the selected entity type in those profiles from the plurality of profiles that represent respective entities of the selected entity type;
including, into a list of suggestions, those profiles that represent respective entities of the selected entity type and also include the input string in the field in profiles in the plurality of profiles that corresponds to the selected entity type;
causing presentation of the list of suggestions on a display device;
detecting a selection, made by a user, from the list of suggestions, of an item of a specified entity type; and
based on the specified entity type of the item selected by the user from the list of suggestions, causing presentation of an invitation, in the search box, to search for items of the specified entity type.

2. The method of claim 1, wherein the list of suggestions comprises a keyword, the keyword includes the input string.

3. The method of claim 1, wherein the list of suggestions comprises a link to a profile that represents an entity of a further entity type and also includes the input string in the key field.

4. The method of claim 1, wherein a profile from the plurality of profiles represent one of a group consisting of a person, a company, and an educational institution.

5. The method of claim 1, comprising:
causing presentation, on the display device, information from a profile represented by the selected item.

6. (canceled)

7. The method of claim 1, comprising:
detecting a selection of an item from the list of suggestions, the item being a keyword;
determining an entity type associated with the keyword and a field in profiles in the plurality of profiles that corresponds to entity type associated with the keyword;
examining the field that corresponds to entity type associated with the keyword in those profiles from the plurality of profiles that represent respective entities of the determined entity type, and
including, in search results, those profiles from the plurality of profiles that represent respective entities of the determined entity type and that also include the keyword in the subject field.

8. The method of claim 7, comprising causing presentation, on the display device, of the search results.

9. The method of claim 1, wherein the computing application is an on-line social network system.

10. The method of claim 1, wherein the entity type identifies profiles from the plurality of profiles that represent one of a group consisting of a company and a person.

11. A computer-implemented system comprising:
an input detector, implemented using at least one processor, to detect an input string in a search box, the search box presented on a display device as part of a user interface of a computing application, the computing application maintaining a plurality of profiles;
an entity type detector, implemented using at least one processor, to select an entity type in response to the detecting, and to determine a field, in profiles in the plurality of profiles, that corresponds to the selected entity type;
a results generator, implemented using at least one processor, to examine, using the input string, the field that corresponds to the selected entity type in those profiles from the plurality of profiles that represent respective entities of the selected entity type to generate a list of suggestions;
the input detector is to detect a selection, made by a user, from the list of suggestions, of an item of a specified entity type;
a presentation module, implemented using at least one processor, to cause presentation of the list of suggestions on a display device and to cause presentation of an invitation, in the search box, to search for items of a specified entity type based on the specified entity type of the item selected by the user from the list of suggestions.

12. The system of claim 11, wherein the list of suggestions comprises a keyword, the keyword includes the input string.

13. The system of claim 11, wherein the list of suggestions comprises a link to a profile that represents an entity of a further entity type and also includes the input string in the key field.

14. The system of claim 11, wherein a profile from the plurality of profiles represent one of a group consisting of a person, a company, and an educational institution.

15. The system of claim 1, wherein:
the presentation module is to cause presentation, on the display device, information from a profile represented by the selected item.

16. (canceled)

17. The system of claim 11, wherein:
the input detector is to detect a selection of an item from the list of suggestions, the item being a keyword;
the entity type detector is to determine an entity type associated with the keyword and a field in profiles in the plurality of profiles that corresponds to entity type associated with the keyword;
the results generator is to:
examine the field that corresponds to entity type associated with the keyword in those profiles from the plurality of profiles that represent respective entities of the determined entity type, and
include, in search results, those profiles from the plurality of profiles that represent respective entities of the determined entity type and that also include the keyword in the subject field.

18. The system of claim 17, wherein the presentation module is to cause presentation, on the display device, of the search results.

19. The system of claim 11, wherein the computing application is an on-line social network system.

20. A machine-readable non-transitory storage medium having instruction data executable by a machine to cause the machine to perform operations comprising:
detecting an input string in a search box, the search box presented on a display device as part of a user interface of a computing application, the computing application maintaining a plurality of profiles;
selecting an entity type in response to the detecting;
determining a field, in profiles in the plurality of profiles, that corresponds to the selected entity type;
using the input string, examining the field that corresponds to the selected entity type in those profiles from the plurality of profiles that represent respective entities of the selected entity type;
including, into a list of suggestions, those profiles that represent respective entities of the selected entity type and also include the input string in the field in profiles in the plurality of profiles that corresponds to the selected entity type;
causing presentation of the list of suggestions on a display device;
detecting a selection, made by a user, from the list of suggestions, of an item of a specified entity type; and
based on the specified entity type of the item selected by the user from the list of suggestions, causing presentation of an invitation, in the search box, to search for items of the specified entity type.
